(19) United States
(12) Patent Application Publication
(10) Pub. No.: US 2010/0053463 A1
(43) Pub. Date: Mar. 4, 2010

(54) MULTI-MEDIA SYSTEM WITH CEC RIGHT TRANSFERRING MECHANISM AND METHOD THEREOF

(76) Inventors: Shui-Chin Yeh, Hsinchu (TW); Jiun-Ji Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/326,008

(22) Filed: Dec. 1, 2008

(30) Foreign Application Priority Data
Sep. 2, 2008 (TW) 097133585

(51) Int. Cl. H04N 5/44

(52) U.S. Cl. 348/734; 348/E05.096

(57) ABSTRACT

A HDMI standard multimedia system includes a source device, a plurality of TVs, and a CEC right arbiter. The CEC right arbiter transfers the right of CEC to an appropriate TV of the plurality of TVs according to each status of the plurality of TVs.

### BACKGROUND OF THE INVENTION

1. Field of the Invention

The present invention relates to a multi-media system and method thereof, and more particularly, to a multi-media system with CEC right transferring mechanism and method thereof.

2. Description of the Prior Art

Reference is made to FIG. 1 for a diagram illustrating a high-definition multimedia interface (HDMI) connector. As depicted in FIG. 1, Pin 13 is used for transmitting a consumer electronics control (CEC) signal. Via Pin 13 of an HDMI, a user can control an HDMI standard DVD player for performing operations such as “Play”, “Fast-forward” and “Rewind”, or an HDMI standard set top box (STB) for switching channels, etc.

Reference is made to FIG. 2 for a table illustrating the definition of logical address (LA) according to HDMI standard. As depicted in FIG. 2, LA “0” is used by TVs, LAs “1”, “2” and “9” are used by recording devices (such as DVD recorders), LAs “3”, “6”, “7” and “10” are used by tuners, LAs “4”, “8” and “11” are used by playback devices (such as DVD players), LA “5” is used by stereos. Meanwhile, Las “12” and “13” are reserved for other undefined devices. LA “14” is used by TVs having physical address (PA) not equal to “0000”. LA “15” is unregistered or for broadcast.

Reference is made to FIG. 3 for a diagram illustrating a prior art multi-media system 100. As depicted in FIG. 3, the multi-media system 100 includes a DVD player 111, an STB 112, a surveillance camera 113, a switch 120, and a TV 131. The DVD player 111, the STB 112, and the surveillance camera 113 can be viewed as source devices of the system, while the TV 131 can be viewed as a sink device or a root device of the system. Each device connected to an HDMI has an LA and a PA. For a source device (TV 131), the LA is set to “0” and the PA is set to “0000”.

Also, the switch 120 can couple the HDMI Pin 13 (CEC) of all source devices (DVD player 111, STB 112, surveillance camera 113) to that of the sink device (TV 131). The switch 120 of the prior art multi-media system 100 is used for enhancing signal strength of source devices only.

Each source device includes a CEC controller coupled to its own HDMI Pin 13 for receiving a control command from the sink device (TV 131), and is thereby capable of performing corresponding operations. For instance, the CEC controller 1111 of the DVD player 111 id coupled to its own HDMI Pin 13. Based on a control command S_{CEC} received from the sink device (TV 131), the DVD player 111 can perform operations such as “Play”, “Fast-forward” and “Rewind”.

The sink device (TV 131) also includes a CEC controller 1311 coupled to its own HDMI Pin 13 for directly transmitting or broadcasting the control command S_{CEC} to each device connected to the HDMI based on a target device. Upon receiving and verifying the control command S_{CEC}, the target device performs corresponding operations. For example, if the TV 131 sends the control command S_{CEC} to LA “4”, then the DVD player 111 performs corresponding operations such as “Play”, “Fast-forward” and “Rewind”

Reference is made to FIG. 4 for a diagram illustrating a prior art multi-media system 200. Though having similar features, the multi-media system 200 differs from the multi-media system 100 in the number of sink devices. As depicted in FIG. 4, the multi-media system 200 includes 3 sink devices TVs 131-133, which are respectively coupled to the ports P₁-P₃ of the switch 120. Since in all sink devices the LA is set to “0” and the PA is set to “0000”, a source device is unable to determine which sink device has sent the control command S_{CEC}, thereby resulting in system confusion. In the prior art, the sink device (TV 131) coupled to the port P₁ of the switch 120 is granted the right of sending the control command S_{CEC}. All source devices can then function according to the control command S_{CEC} Sent by the TV 131, thereby avoiding system confusion.

However, prior art multi-media system may cause inconvenience to users since the sink devices TVs 132 and 133 respectively coupled to the ports P₂ and P₃ of the switch 120 can not be used for controlling a source device. For example, according to user arrangement, the TV 131 is disposed in the living room, the TV 132 is disposed in the bedroom, and the TV 133 is disposed in the bathroom. When the user is in the living room watching TV, the TV 131 is in active mode and can be used for controlling each source device. When the user enters the bedroom or the bathroom and leaves the living room, the TV 131 enters standby mode. Under this circumstance, the TVs 132 and 133 can not be used for controlling each source device.

### SUMMARY OF THE INVENTION

The present invention provides a multi-media system with CEC right transferring mechanism, comprising a source device having an HDMI for performing operations based on a CEC command; a first sink device having an HDMI and comprising a memory device for storing a first identification data and a CEC controller for receiving a second identification data and thereby enabling the first sink device to transmit the CEC command based on the first and second identification data; a second sink device having an HDMI and comprising a memory device for storing a third identification data and a CEC controller for receiving the second identification data and thereby enabling the second sink device to transmit the CEC command based on the third and second identification data; and a switch having an HDMI and coupled between the source device, the first sink device and the second sink device comprising a first port coupled to the first sink device; a second port coupled to the second sink device; and a CEC right arbiter coupled between the first and second ports for respectively transmitting the first and third identification data to the first and second sink devices and for transmitting the second identification data based on status of the first and second sink devices during initialization.

The present invention provides a multi-media system with CEC right transferring mechanism, comprising a source device having an HDMI for performing operations based on a CEC command; a first sink device having an HDMI and comprising a memory device for storing a first identification data and a CEC controller for receiving a second identification data and thereby enabling the first sink device to transmit the CEC command based on the first and second identification data; a second sink device having an HDMI and comprising a CEC controller for transmitting the CEC command; and a switch having an HDMI and coupled between the source device, the first sink device and the second sink device, and comprising a first port coupled to the first sink device, a second port coupled to the second sink device, and a CEC right arbiter coupled between the first and second ports for transmitting the first identification data to the first sink device and for transmitting the second identification data based on status of the first sink device during initialization.

The present invention provides a multi-media system with CEC right transferring mechanism comprising a source device having an HDMI for performing operations based on a CEC command; a first sink device having an HDMI and comprising a CEC controller for transmitting the CEC command; a second sink device having an HDMI and comprising a CEC controller for transmitting the CEC command; and a switch having an HDMI and coupled between the source device, the first sink device and the second sink device, and comprising a first port coupled to the first sink device, a second port coupled to the second sink device, and a CEC right arbiter coupled between the first and second ports for transmitting the CEC command transmitted from the first sink device or from the second sink device to the source device based on a setting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an HDMI connector

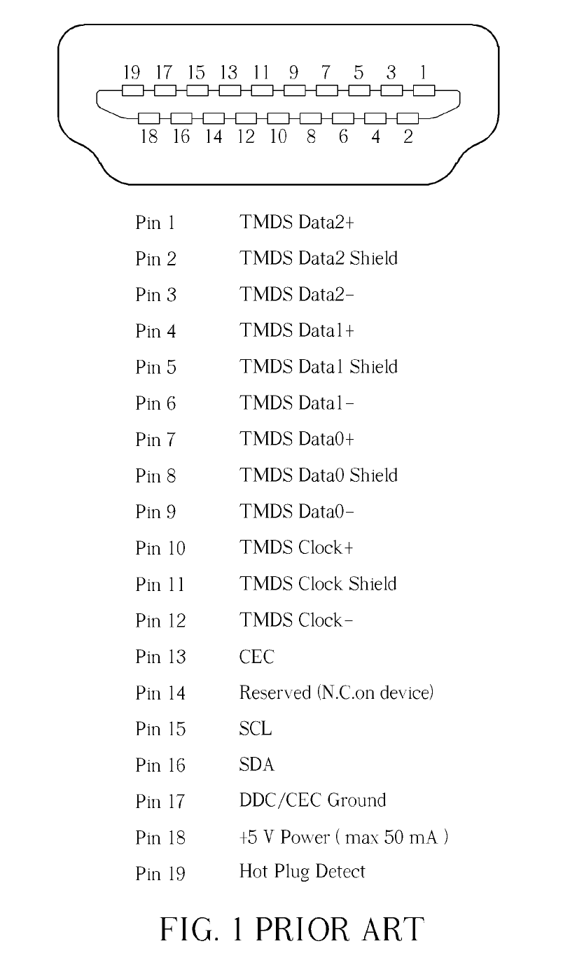

FIG. 2 is a table illustrating the definition of logical address according to HDMI standard.

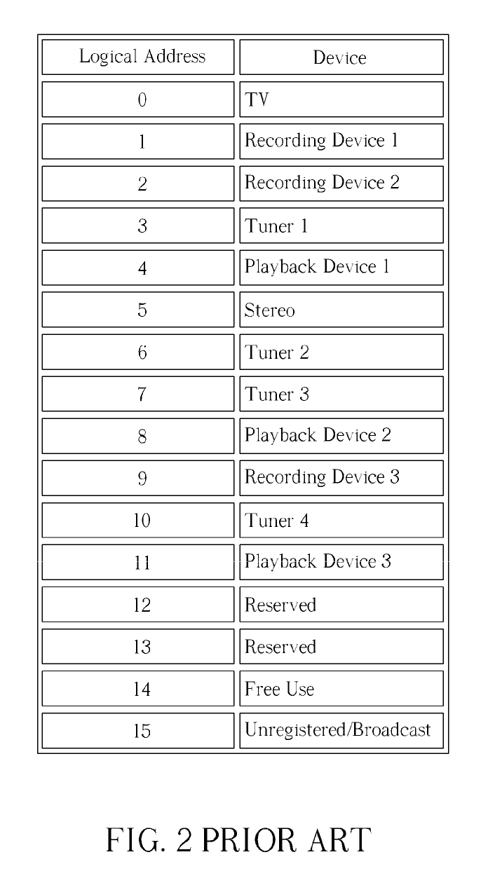

FIG. 3 is a diagram illustrating a prior art multi-media system.

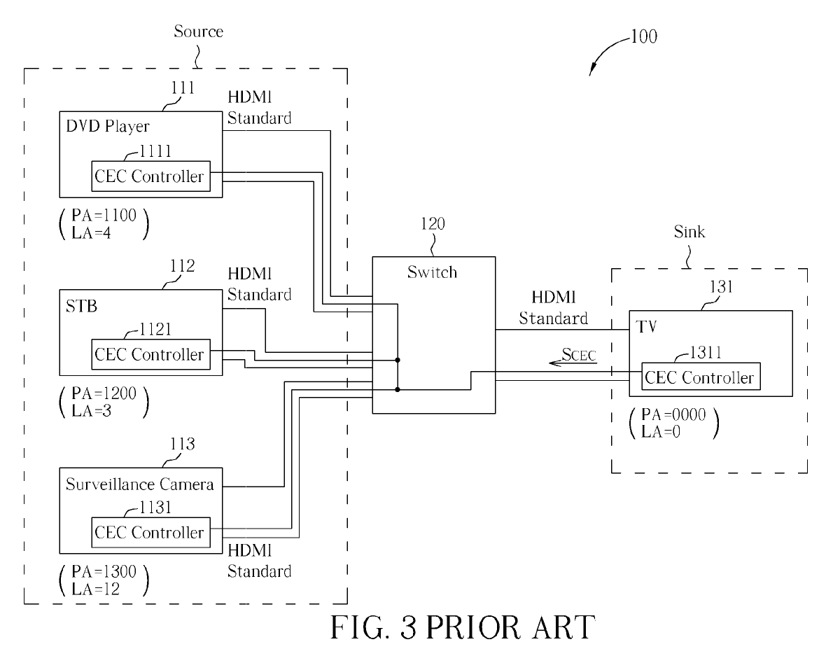

FIG. 4 is a diagram illustrating another prior art multi-media system.

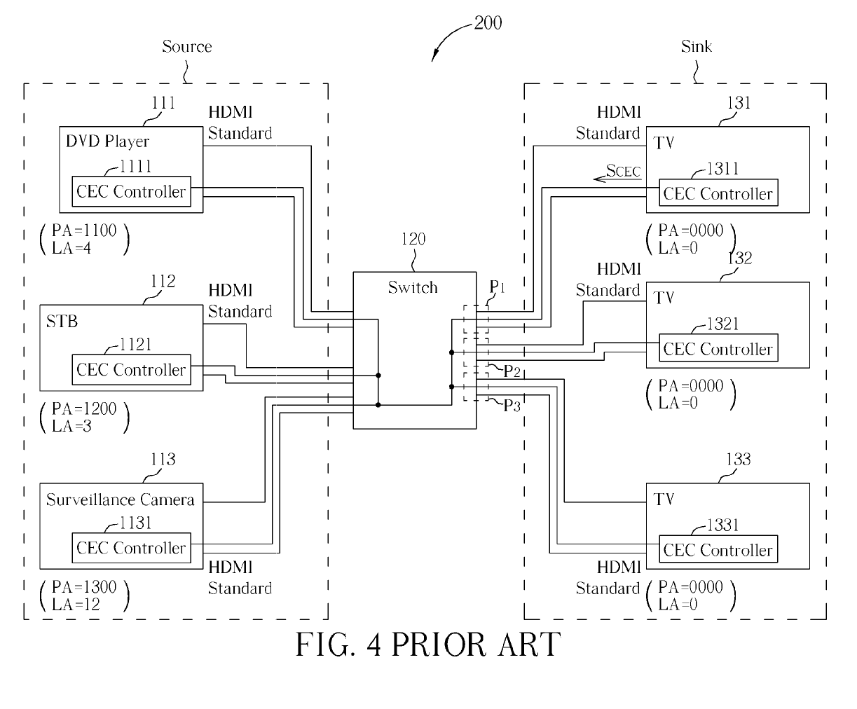

FIG. 5 is a diagram illustrating a multi-media system with CEC right transferring mechanism according to a first embodiment of the present invention.

FIG. 6 is a diagram illustrating a multi-media system when performing CEC right transfer according to the present invention.

FIG. 7 is a diagram illustrating another multi-media system when performing CEC right transfer according to the present invention.

FIG. 8 is a flowchart illustrating a method for controlling a multi-media system with CEC right transferring mechanism.

FIG. 9 is a flowchart illustrating another method for controlling a multi-media system with CEC right transferring mechanism.

### DETAILED DESCRIPTION

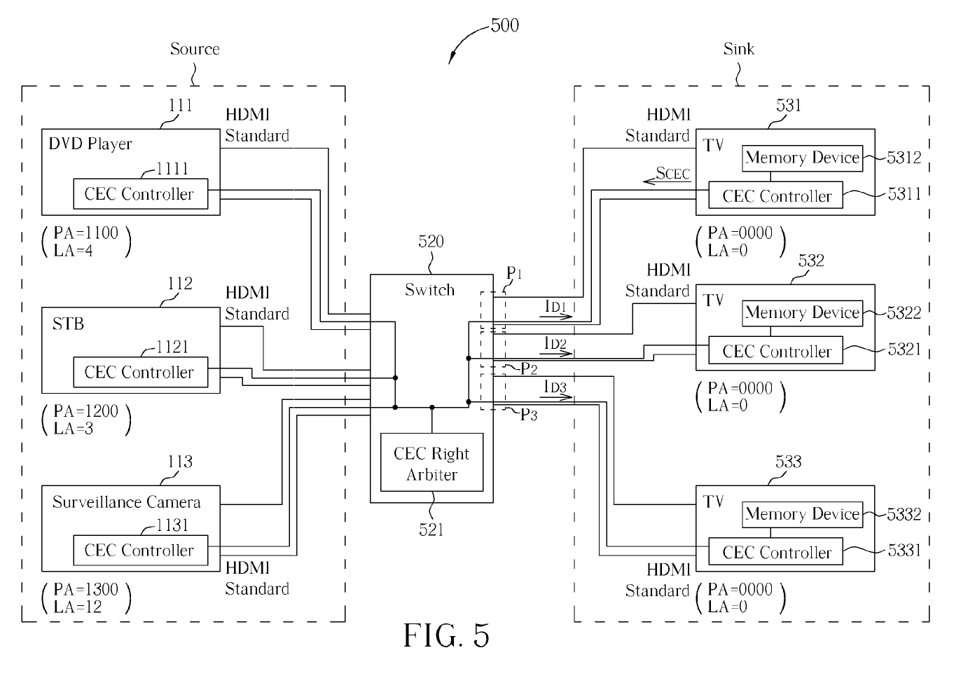

Reference is made to FIG. 5 for a diagram illustrating a multi-media system 500 with CEC right transferring mechanism according to a first embodiment of the present invention. As depicted in FIG. 5, the multi-media system 500 includes the DVD player 111, the STB 112, the surveillance camera 113, a switch 520, and TVs 531-533. The DVD player 111, the STB 112, and the surveillance camera 113 can be viewed as source devices of the system, while the TVs 531-533 can be viewed as sink devices or root devices of the system. Each device connected to an HDMI has an LA and a PA. For sink devices (TVs 531-533), the LA is set to “0” and the PA is set to “0000”.

In addition to enhancing signal strength of the source devices, the switch 520 of the present invention further includes a CEC right arbiter 521. The HDMI Pin 13 (CEC) of all source devices (DVD player 111, STB 112, surveillance camera 113) can be coupled to those of the sink devices (TVs 531-533) respectively and to the CEC right arbiter 521.

The source devices, the DVD player 111, the STB 112, and the surveillance camera 113, respectively include CEC controllers 1111, 1121 and 1131 coupled to corresponding HDMI Pins 13 for receiving a control command from the sink devices (TVs 531-533), and are thereby capable of performing corresponding operations. For instance, the CEC controller 1111 of the DVD player 111 is coupled to its own HDMI Pin 13. Based on the control command S_{CEC} received from the sink devices (TVs 531-533), the DVD player 111 can perform operations such as “Play”, “Fast-forward” and “Rewind”.

Meanwhile, the TVs 531, 532 and 533 also respectively include CEC controllers 5311, 5321 and 5331 coupled to corresponding HDMI Pins 13 for directly sending or broadcasting a control command S_{CEC} to all devices connected to the HDMI based on a target source device. For example, if the TV 531 sends a control command S_{CEC} having LA set to “4”, the DVD player 111 then performs corresponding operations such as “Play”, “Fast-forward” and “Rewind”.

The TVs 531, 532 and 533 further include memory devices 5312, 5322 and 5332 for storing respective identification data. The memory devices 5312, 5322 and 5332 can include random access memory (RAM).

During initialization when identification data has not been stored in the TVs 531-533, the CEC right arbiter 521 is used for providing the TVs 531-533 with identification data. Based on the ports P1-P3 to which the TVs 531-533 are respectively connected, the CEC right arbiter 521 respectively provides the TVs 531-533 with identification data ID₁-ID₃, which is respectively stored in the memory devices 5312, 5322 and 5332.

After respectively bestowing the identification data ID₁-ID₃ on the TVs 531-533, the CEC right arbiter 521 can grant the CEC right to the TV 531 with the identification data ID₁. To be more precise, when the TVs 531-533 are all in active mode, the CEC right arbiter 521 makes a broadcast to the TVs 531-533, thereby informing that the CEC right is currently owned by a device having the identification data ID₁. The CEC controllers 5311, 5321 and 5331 of the TVs 531, 532 and 533 can then compare the identification data broadcast by the CEC right arbiter 521with those stored in the 5312, 5322 and 5332, respectively. For instance, if the identification data ID₁ is associated with the CEC right in the broadcast made by the CEC right arbiter 521, only the CEC controller 5311 can locate a matched identification data stored in the memory device 5312. As a result, the TV 531 can send the CEC command S_{CEC} via the CEC controller 5311, thereby controlling each source device for performing corresponding operations.

Upon entering standby mode, the TV 531 informs the CEC right arbiter 521 via the CEC controller 5311 and releases the CEC right, which can then be granted to the TV 532 having the identification data ID₂ or the TV 533 having the identification data ID₃, depending on user request. To be more precise, after the TV 531 enters standby mode and releases the CEC right, the CEC right arbiter 521 makes another broadcast to the TVs 531-533, thereby informing that the CEC right is currently owned by a device having the identification data ID₂ or ID₃. For instance, if the identification data ID₂ is associated with the CEC right in the broadcast made by the CEC right arbiter 521, only the CEC controller 5321 can locate a matched identification data stored in the memory device 5322. As a result, the TV 532 can send the CEC command S_{CEC} via the CEC controller 5321, thereby controlling each source device for performing corresponding operations.

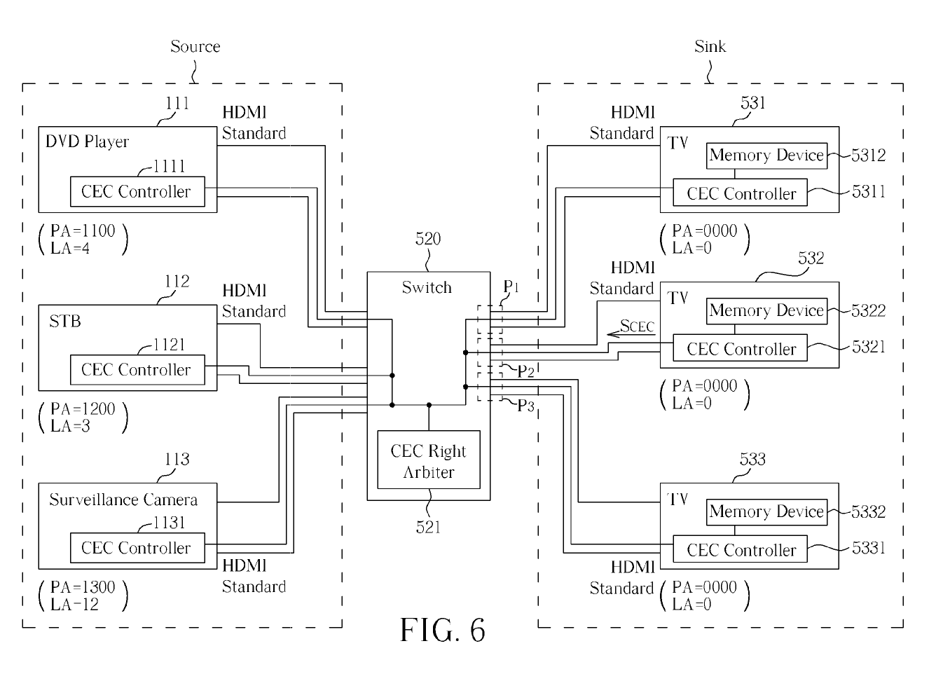

Reference is made to FIG. 6 for a diagram illustrating the multi-media system 500 after the TV 531 enters standby mode and releases the CEC right. As depicted in FIG. 6, when the TV 531 is in standby mode, the CEC right arbiter 521 gives the CEC right to the TV 532 having the identification data ID₂. As a result, the TV 532 can control each source device for performing corresponding operations by sending the CEC command S_{CEC}.

In the multi-media system 500, all of the TVs 531-533 must be able to transfer the CEC right based on the CEC command S_{CEC} sent by the CEC right arbiter 521. Supposed one of the TVs 531-533 (assuming the TV 531) does not support such function when the CEC right arbiter 521 requests a CEC right transfer from the TV 531 to the TV 533, the TV 531 may continue to possess the CEC right, thereby causing system confusion.

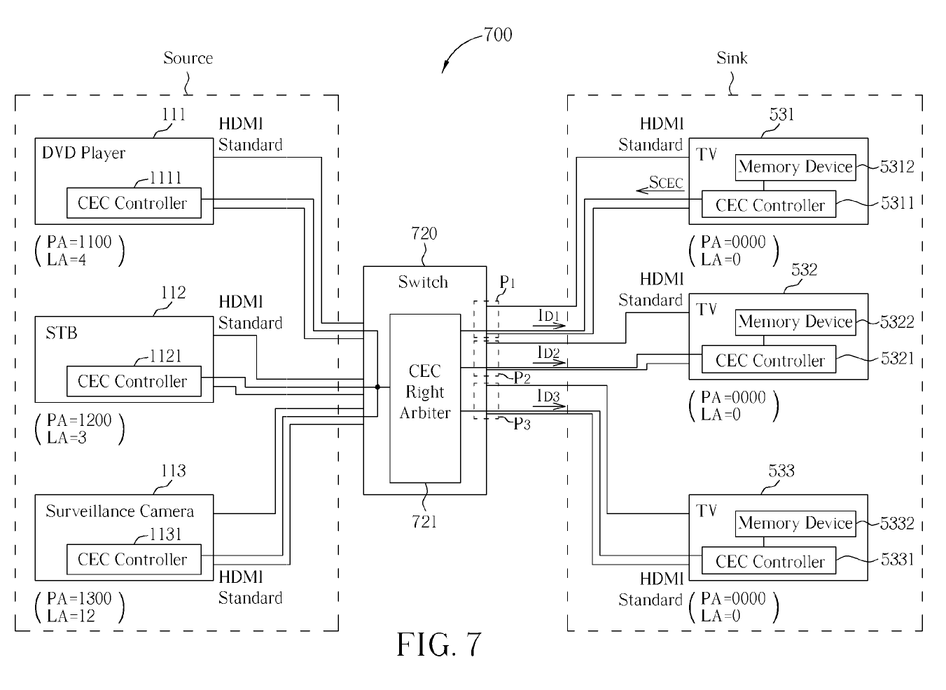

Reference is made to FIG. 7 for a diagram illustrating a multi-media system 700 with CEC right transferring mechanism according to a second embodiment of the present invention. As depicted in FIG. 7, the multi-media system 700 includes the DVD player 111, the STB 112, the surveillance camera 113, a switch 720, and the TVs 531-533. The DVD player 111, the STB 112, and the surveillance camera 113 can be viewed as source devices of the system, while the TVs 531-533 can be viewed as sink devices or root devices of the system. Each device connected to an HDMI has an LA and a PA. For sink devices (TVs 531-533), the LA is set to “0” and the PA is set to “0000”. In addition to enhancing signal strength of the source devices, the switch 720 of the present invention further includes a CEC right arbiter 721. Similar features between the multi-media systems and 500 and 700 will not described again. The multi-media system 700 differs from the multi-media system 500 in that the HDMI Pins 13 (CEC) of the source devices (DVD player 111, STB 112, surveillance camera 113) are short-circuited first before being coupled to the CEC right arbiter 721, while the HDMI Pins 13 (CEC) of the TVs 531-533 are respectively coupled to the CEC right arbiter 721. As a result, the multi-media system 700 can avoid system confusion if the TVs 531-533 are not capable of transferring CEC right. In addition, if the TV 531 is not capable of transferring CEC right, the memory device 5312 is not necessary since there is no need to store the identification data sent from the CEC right arbiter 721.

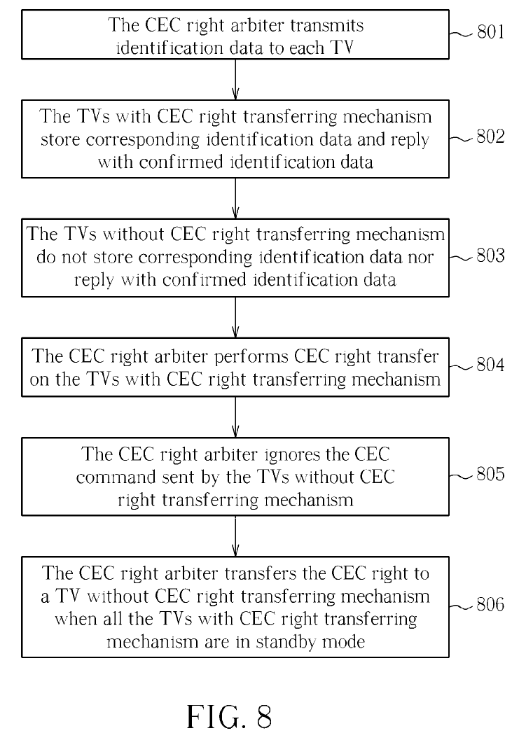

Reference is made to FIG. 8 for a method 800 for controlling the multi-media system 700 with CEC right transferring mechanism. In the method 800, the TVs 531 and 532 can perform CEC right transfer, while the TV 533 is incapable of such function. FIG. 8 includes the following steps:

Step 801: the CEC right arbiter 721 transmits identification data to each of the TVs 531-533;

Step 802: the TVs 531 and 532 store corresponding identification data and reply with confirmed identification data so that the CEC right arbiter 721 can be informed of the ability to transfer CEC right;

Step 803: the TV 533 does not store corresponding identification data nor reply with confirmed identification data so that the CEC right arbiter 721 can be informed of the inability to transfer CEC right;

Step 804: the CEC right arbiter 721 performs CEC right transfer on the TVs 531 and 532;

Step 805: the CEC right arbiter 721 ignores the CEC command sent by the TV 533;

Step 806: the CEC right arbiter 721 transfers the CEC right to the TV 533 when both the TVs 531 and 532 are in standby mode.

In the method 800, the CEC right arbiter 721 first transmits corresponding identification data to each of the TVs 531-533. For a TV capable of performing CEC right transfer, the received identification data is stored and a confirmed identification data is replied for informing the CEC right arbiter 721 of its CEC right transferring ability. On the other hand, a TV incapable of performing CEC right transfer does not store the received identification data nor replied with a confirmed identification data. Under this circumstance, the CEC right arbiter 721 can be informed of its inability to transfer CEC right. In step 806, the CEC right arbiter 721 sends the CEC command S_{CEC} received from the TV 533 directly to the source device for performing corresponding operations.

In addition, the CEC right arbiter 721 can isolate the CEC pins of the source devices from those of the sink devices. Therefore, a sink device with CEC right transferring and a sink device without CEC right transferring can avoid interfering each other.

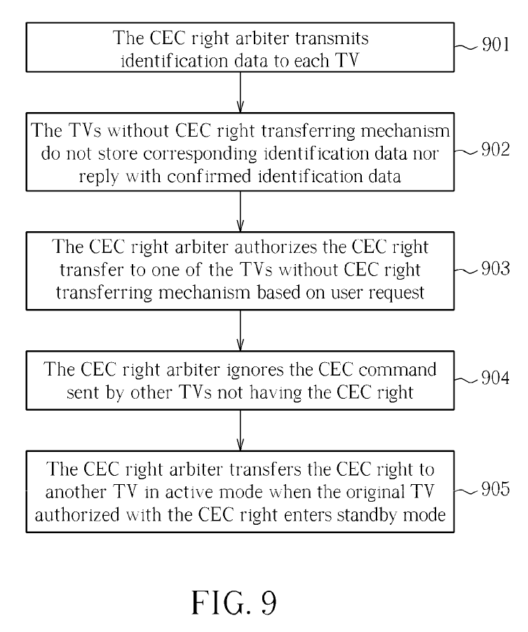

Reference is made to FIG. 9 for a method 900 for controlling the multi-media system 700 with CEC right transferring mechanism. In the method 900, all of the TVs 531-533 are unable to perform CEC right transfer. FIG. 9 includes the following steps:

Step 901: the CEC right arbiter 721 transmits identification data to each of the TVs 531-533;

Step 902: the TVs 531-533 do not store corresponding identification data nor reply with confirmed identification data so that the CEC right arbiter 721 can be informed of the inability to transfer CEC right;

Step 903: the CEC right arbiter 721 authorizes the CEC right to one of the TVs 531-533 based on user request;

Step 904: the CEC right arbiter 721 ignores the CEC command sent by other TVs not having the CEC right;

Step 905: the CEC right arbiter 721 transfers the CEC right to another TV in active mode when the original TV authorized with the CEC right enters standby mode.

In the method 900, the CEC right arbiter 721 can isolate the CEC pins of the source devices from those of the sink devices. Therefore, a sink device with CEC right transferring and a sink device without CEC right transferring can avoid interfering each other. In steps 904 and 905, the CEC right arbiter 721 selectively transmits to CEC command S_{CEC} to the source devices.

CEC right can by dynamically switched in the multi-media systems according to the present invention. For example, when watching TV in the living room, the user can control each source device via the TV in the living room. When the user leaves the living room and enters the bedroom, the TV in the living room enters standby mode and releases the CEC right to the TV in the bedroom. Therefore, the user can also control each source device via the TV in the bedroom. The present invention can thus provide users with more flexibility and convenience.

Those skilled in the art will readily observe that numerous modifications and alterations of the device and method may be made while retaining the teachings of the invention.

What is claimed is:

1. A multi-media system with consumer electronics control (CEC) right transferring mechanism, comprising:
a source device having a high-definition multimedia interface (HDMI) for performing operations based on a CEC command;
a first sink device having an HDMI, comprising:
a memory device for storing a first identification data; and
a CEC controller for receiving a second identification data and thereby enabling the first sink device to transmit the CEC command based on the first and second identification data;
a second sink device having an HDMI, comprising:
a memory device for storing a third identification data; and
a CEC controller for receiving the second identification data and thereby enabling the second sink device to transmit the CEC command based on the third and second identification data; and
a switch having an HDMI and coupled between the source device, the first sink device and the second sink device, comprising:
a first port coupled to the first sink device;
a second port coupled to the second sink device; and
a CEC right arbiter coupled between the first and second ports for respectively transmitting the first and third identification data to the first and second sink devices and for transmitting the second identification data based on status of the first and second sink devices during initialization.

2. The multi-media system of claim 1 wherein the CEC controller of the first sink device enables the first sink device to transmit the CEC command when the first and second identification data are identical.

3. The multi-media system of claim 1 wherein the CEC controller of the second sink device enables the second sink device to transmit the CEC command when the third and second identification data are identical.

4. The multi-media system of claim 1 wherein the CEC right arbiter transmits the second identification data which is identical to the first identification data when the first sink device is in active mode.

5. The multi-media system of claim 4 wherein the CEC right arbiter transmits the second identification data which is identical to the third identification data when the first sink device is in standby mode.

6. The multi-media system of claim 1 wherein the first and second sink devices include TVs.

7. A multi-media system with CEC right transferring mechanism, comprising:
a source device having an HDMI for performing operations based on a CEC command;
a first sink device having an HDMI, comprising:
a memory device for storing a first identification data; and
a CEC controller for receiving a second identification data and thereby enabling the first sink device to transmit the CEC command based on the first and second identification data;
a second sink device having an HDMI, comprising:
a CEC controller for transmitting the CEC command; and
a switch having an HDMI and coupled between the source device, the first sink device and the second sink device, comprising:
a first port coupled to the first sink device;
a second port coupled to the second sink device; and
a CEC right arbiter coupled between the first and second ports for transmitting the first identification data to the first sink device and for transmitting the second identification data based on status of the first sink device during initialization.

8. The multi-media system of claim 7 wherein the CEC controller of the first sink device enables the first sink device to transmit the CEC command to the source device when the first and second identification data are identical.

9. The multi-media system of claim 7 wherein the CEC right arbiter transmits the CEC command received from the second sink device to the source device when the first sink device is in standby mode.

10. The multi-media system of claim 7 wherein the first and second sink devices include TVs.

11. A multi-media system with CEC right transferring mechanism, comprising:
a source device having an HDMI for performing operations based on a CEC command;
a first sink device having an HDMI, comprising:
a CEC controller for transmitting the CEC command;
a second sink device having an HDMI, comprising:
a CEC controller for transmitting the CEC command; and
a switch having an HDMI and coupled between the source device, the first sink device and the second sink device, comprising:
a first port coupled to the first sink device;
a second port coupled to the second sink device; and
a CEC right arbiter coupled between the first and second ports for transmitting the CEC command transmitted from the first sink device or from the second sink device to the source device based on a setting.

12. The multi-media system of claim 11 wherein the CEC right arbiter transmits the CEC command received from the second sink device to the source device when the first sink device is in standby mode.

13. The multi-media system of claim 11 wherein the CEC right arbiter transmits the CEC command received from the first sink device to the source device when the second sink device is in standby mode.

14. The multi-media system of claim 11 wherein the first and second sink devices include TVs.
